(19) United States
(12) Patent Application Publication
(10) Pub. No.: US 2004/0093284 A1
(43) Pub. Date: May 13, 2004

(54) System and method for supporting sales of vehicle

(75) Inventors: Hiroki Takaoka, Hiroshima-ken (JP); Shigefumi Hirabayashi, Hiroshima-ken (JP); Norihiko Uchida, Hiroshima-ken (JP)

Correspondence Address: STAAS & HALSEY LLP, SUITE 700, 1201 NEW YORK AVENUE, N.W., WASHINGTON, DC, 20005, US

(73) Assignee: Mazda Motor Corporation, Hiroshima (JP)

(21) Appl. No.: 10/649,993

(22) Filed: Aug. 28, 2003

(30) Foreign Application Priority Data
Sep. 2, 2002 (JP) 2002-257020
Sep. 2, 2002 (JP) 2002-257021

(51) Int. Cl. G06F 17/60

(52) U.S. Cl. 705/27

(57) ABSTRACT

There is disclosed a server which provides a high quality service taking into account a balance of business processing of a dealer and a desire of a client. More specifically, the server in accordance with the present invention receives specification information specifying specifications of a vehicle and an estimation request, and decides whether to sends an estimated price stored in an estimated price database to the client terminal or to inquire an estimated price from a dealer. In addition, the server in accordance with the present invention refers to automatic reply prohibited client data and decides whether or not the client is stored in the data as a client to whom an estimated price should not be automatically returned. Moreover, the server in accordance with the present invention decides whether or not a comment of the client is included in estimation request data from the client. If the client is stored in the automatic reply prohibited client data or a comment is included in the estimation request data, the server sends specification information and client information to the dealer terminal and requests calculation of an individual estimated price.

### FIELD OF THE INVENTION

The present invention relates to a technique for supporting sales of a vehicle using a computer.

### BACKGROUND OF THE INVENTION

Presently, there exists a service for causing a client to select various parts and presenting a manufacturer's suggested price for a vehicle, which is manufactured by combining the selected parts, via a network. In such a service, basically, information is exchanged over a network between a server managed by the manufacturer of the vehicle and a client terminal operated by the client. Recently, such a service has been developed such that a manufacturer presents its suggested price and, in addition, a dealer of a vehicle presents an estimated price, which it has determined independently, to a client. In the case in which an estimated price is presented in this way, a server of the manufacturer embeds an estimated price, which is stored in an estimated price database, in a stereotyped sentence prepared in advance, and automatically sends a reply to all clients who have requested estimation by an electronic mail.

However, in the conventional system, the stereotyped sentence is simply returned by an electronic mail, an insipid impression may be given to the clients. In addition, since communication between the dealer and the clients becomes sparse, information, which can be obtained in the case in which an estimated price is presented to a client directly to sell a vehicle over the counter, cannot be obtained. Such information includes information on why a client gave up the purchase of a vehicle at a certain estimated price and information on how much discount on an estimated price would have encouraged a client to determine the purchase of the vehicle.

Therefore, such a system has insufficient materials for updating an estimated price, an estimated price stored in the database is hardly changed. Consequently, some clients express dissatisfaction in that the estimated price is too high or the clients cannot enjoy price negotiation in purchasing a vehicle.

Still, if a salesclerk calculates estimated prices for all clients, who have requested estimation via the system, one by one, processing of operations becomes complicated.

### SUMMARY OF THE INVENTION

According to one aspect of the present invention, preferably, there is provided a sales support server which is capable of communicating with an estimated price database, in which specifications for vehicles and estimated prices in selling the vehicles are stored in association with each other for a plurality of kinds of vehicles, a dealer terminal used by a dealer of vehicles, and a client terminal each other via a network, the sales support server is characterized by comprising; a reception unit which receives specification information specifying specifications for a vehicle and an estimation request from the client terminal; a reading unit which reads an estimated price from the estimated price database based upon the specification information; a first transmission unit which sends the estimated price read by the reading unit to the client terminal; a second transmission unit which sends the specification information received by the reception unit to the dealer terminal in order to inquire an estimated price from the dealer; and a control unit which, when the estimation request is received by the reception unit, decides whether to send the estimated price stored in the estimated price database to the client terminal or to inquire the estimated price from the dealer, and controls the first transmission unit or the second transmission unit.

According to the other aspect of the present invention, preferably, there is provided a sales support system, including; a sales support server managed by a manufacturer of vehicles; a dealer terminal used by a dealer of vehicles; a client terminal; and an estimated price database, in which specifications for vehicles and estimated prices to be automatically transmitted for the vehicles are stored in association with each other for a plurality of kinds of vehicles, the sales support server, the dealer terminal, the client terminal, and the estimated price database are capable of communicating with each other via a network, characterized in that the sales support server comprises; a reception unit which receives specification information specifying specifications for a vehicle and an estimation request from the client terminal; a reading unit which reads an estimated price to be automatically transmitted from the estimated price database based upon the specification information; a first transmission unit which sends the estimated price to be automatically transmitted read by the reading unit to the client terminal; a second transmission unit which sends the specification information received by the reception unit to the dealer terminal in order to inquire an estimated price from the dealer; and a control unit which, when the estimation request is received by the reception unit, decides whether to send the estimated price to be automatically transmitted stored in the estimated price database to the client terminal or to inquire the estimated price from the dealer, and controls the first transmission unit or the second transmission unit.

According to still other aspect of the present invention, preferably, there is provided a sales support method which uses a sales support server managed by a manufacturer of vehicles, a dealer terminal used by a dealer of vehicles, a client terminal, and an estimated price database in which specifications for vehicles and estimated prices to be automatically transmitted for the vehicles are stored in association with each other for a plurality of kinds of vehicles, characterized by comprising; a reception step in which the sales support server receives specification information specifying specifications for a vehicle and an estimation request from the client terminal; a decision step of, when the estimation request is received in the reception step, deciding whether to send an estimated price to be automatically transmitted stored in the estimated price database to the client terminal or to inquire an estimated price from the dealer; a first transmission step of, if it is decided in the decision step to send the estimated price to be automatically transmitted stored in the estimated price database to the client terminal, reading the estimated price to be automatically transmitted from the estimated price database based upon the specification information received in the reception step and sending the estimated price to the client terminal; and a second transmission step of, if it is decided in the decision step to inquire the estimated price from the dealer, sending the specification information received in the reception step to the dealer terminal.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a diagram showing an overall structure of a sales support system as an embodiment of the present invention;

FIG. 2 is a diagram showing an internal structure of an estimated price database of the sales support system as the embodiment of the present invention;

FIG. 3 is a diagram illustrating a service provision method according to the sales support system as the embodiment of the present invention;

FIG. 4 is a diagram showing an example of a specification selection screen presented by a BTO server 1 in accordance with the embodiment of the present invention;

FIG. 5 is a diagram showing an example of an estimation input screen presented by the BTO server 1 in accordance with the embodiment of the present invention;

FIG. 6 is a diagram showing an example of a reference information screen presented by the BTO server 1 in accordance with the embodiment of the present invention;

FIG. 7 is a diagram showing an example of an electronic mail for notification of business talk failure sent by the BTO server 1 in accordance with the embodiment of the present invention;

FIG. 8 is a diagram showing an example of an electronic mail for follow-up request sent by the BTO server 1 in accordance with the embodiment of the present invention; and

FIG. 9 is a flowchart showing a method of deciding propriety of automatic reply in the BTO server 1 in accordance with the embodiment of the present invention.

### DETAILED DESCRIPTION OF THE PREFERRED EMBODIMENTS

First, a sales support system as an embodiment of the present invention is a system for providing a BTO (Build To Order) service which causes a client to select various parts and presenting a manufacturer's suggested price and an estimated price for a vehicle, which is manufactured by combining the selected parts, via a network.

Therefore, an individual specification car in the embodiment described below means a vehicle for which a client selects specification according to his/her own preference out of a plurality of options such as parts and colors and combines the specifications utilizing the BTO service of this sales support system.

In addition, a client means a person who is capable of accessing the system in accordance with this embodiment to receive a service thereof, who is a prospective customer or the like who is considering purchase of the individual specification car.

Structure of Entire System

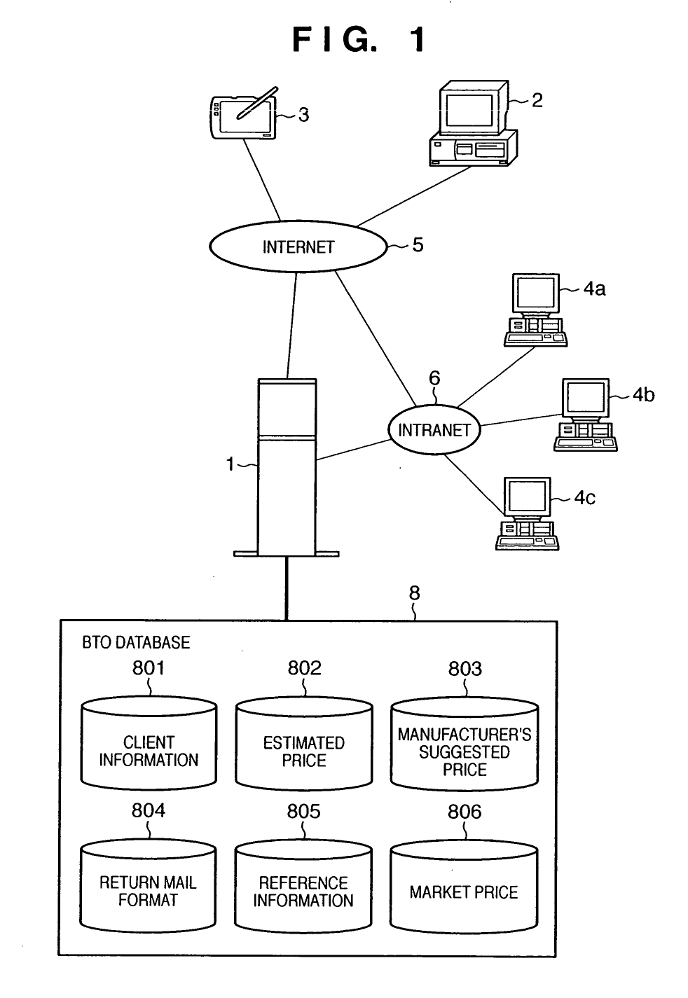

FIG. 1 is a conceptual diagram showing an overall structure of the sales support system in accordance with this embodiment.

In the figure, the sales support system includes a BTO server 1 serving as a sales support server for vehicles, a desktop computer 2 and a PDA 3 serving as client terminals, and dealer terminals 4 (4a to 4c) which are installed and managed for each dealer. The BTO server 1, the desktop computer 2 and the PDA 3, and the dealer terminals 4 are capable of communicating with each other via the Internet 5 and an Intranet 6. Note that, here, for convenience of illustration, only two client terminals and three dealer terminals are shown. However, it is needless to mention that this system can include more client terminals and dealer terminals.

Among them, the BTO server 1 is capable of further communicating with a database 8 and is also capable of writing various kinds of information in and reading them from the database 8 according to an operation in the desktop computer 2 or the PDA 3 or an instruction from the dealer terminal 4.

Moreover, although not illustrated, the BTO server 1 is provided with web contents, which include plug-in for displaying a screen for BTO service on the desktop computer 2 and the PDA 3, and a CGI (Common Gateway Interface) program for receiving specification information of a vehicle from the desktop computer 2 or the PDA 3, reading a manufacturer's suggested price and an estimated price according to the received specification information from the database 8, and returning the manufacturer's suggested price and the estimated price to those terminals. In addition, the BTO server 1 has a hardware configuration of a general server to which an IP address is assigned, and is provided with a CPU, a memory, a hard disk, and the like other than a communication device. Thus, the BTO server 1 is capable of accessing other servers and databases on the Internet.

Consequently, a client can acquire an estimated price for a desired individual specification car while accessing the BTO server 1 via the Internet and browsing the web contents prepared in the BTO server with a browser installed in the desktop computer 2 or the PDA 3.

The desktop computer 2, the PDA 3, and the dealer terminals 4a, 4b, 4c are general information terminals, and have at least a communication device which utilizes a general communication protocol such as TCP/IP, a browser for accessing a server on the Internet 5 utilizing the communication device to browse web contents, and a mailer for exchanging mails with terminals connected to the Internet 5. It goes without saying that a CPU and a memory for operating the browser and the mailer are also implemented.

On the other hand, as shown in the figure, the database 8 includes a client information database 801, an estimated price database 802, a manufacturer's suggested price database 803, a return mail format by dealer database 804, a reference information database 805, and a market price database 806. Then, various kinds of information described below are stored in the respective databases in a state in which those kinds of information are associated with each other appropriately.

The client information database 801 stores various kinds of information such as client names, client IDs, passwords, mail addresses, addresses, telephone numbers, and estimation request IDs associating them with each other. Note that the estimation request ID is information for identifying data concerning estimation requested in the past. By referring to this estimation request ID, it becomes possible to read not only the number of times of estimation request but also information on dates and times of an estimation request and a reply, and a dealer which has made estimation from the estimated price database.

The estimated price database 802 stores a plurality of kinds of specification information, which are prepared in advance such that clients specify individual specification cars, and estimated prices in selling the individual specification cars specified by these kinds of information associating them with each other. Note that these estimated prices are stored for each dealer, and an estimation history in the past and the like are also stored.

The manufacturer's suggested price database 803 stores a plurality of individual specification cars, which are specified by specification information, and manufacturer's suggested prices, which are set by manufacturers in advance for the respective individual specification cars, associating them with each other.

The return mail format database 804 stores format data (template information) which is used in presenting an estimated price in response to an estimation request from a client. In this embodiment, since a reply of estimation is sent by an electronic mail, this format data is arranged in a template form corresponding to a mailer.

The reference information database 805 stores sales histories and the like for each dealer as information which is used as a reference when a salesclerk of a dealer calculates an estimated price.

The market price database 806 stores price information concerning various vehicles which are sold by other vehicle manufacturers. For example, the market price database 806 is referred to when the respective dealers present estimated prices to clients or update data of the estimated price database.

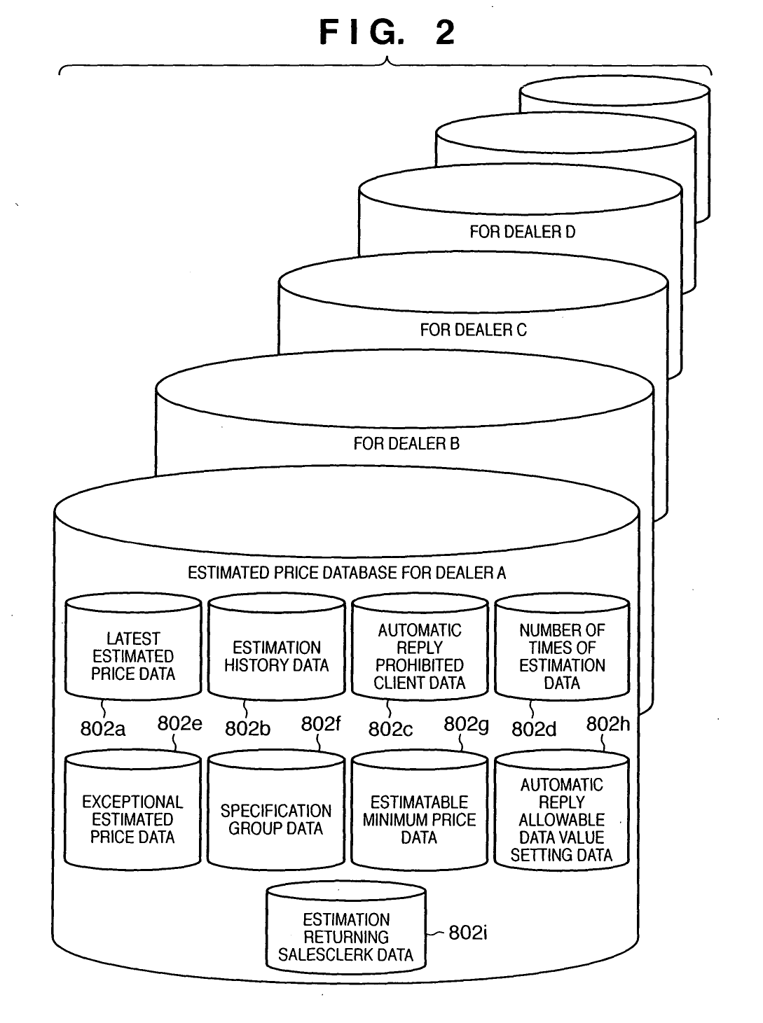

In addition, although not illustrated here, in addition to the above, the database 8 includes a database in which information on dealers (addresses of salesclerks, etc.), a database in which information on parts selectable for each model, and the like. Next, detailed contents of the estimated price database 802 will be described with reference to FIG. 2. As shown in the figure, the estimated price database 802 is prepared individually for each of all dealers.

Further, the estimated price database 802 for each dealer includes data described below.

Latest estimated price data 802a: An estimated price which is automatically presented in response to an estimation request from a client is stored in this data. An estimated price returned to the client individually from a dealer is stored, in principle, in this data as an estimated price for automatic reply excluding an exceptional case. However, in order to maintain freshness of an estimated price, the estimated price stored here is automatically deleted when a predetermined period has elapsed. Therefore, even if an estimation request is received from a client, it is possible that an estimated price corresponding to specification information therefor is not stored. In addition, this data can be inputted and updated also by operation according to approval of a representative of the dealer.

Estimated price history data 802b: Prices which were estimated for clients in the past and are not latest estimated prices are stored in this data. That is, prices which are stored here are estimated prices which were stored as the latest estimated price data 802a but were overwritten due to updating or estimated prices which were deleted due to elapse of a predetermined period.

Automatic reply prohibited client data 802c: IDs of clients for whom automatic reply should not be performed are stored in this data. It is necessary to prevent good customers from getting an unfavorable impression caused by automatic reply. Thus, the BTO server 1 decides whether automatic reply may be performed for a client with reference to this data 802c.

Number of times of estimation data 802d: The number of times of estimation data is data in which the number of times of estimation request is stored for each client. A client who has sent estimation request many times to the same dealer is considered to have relative high desire to purchase. Therefore, in order to build a close relation with such a client and encourage the client to purchase a vehicle, the number of times of estimation request is counted for each client and, a client whose number of times of estimation request has exceeded a predetermined number of times is registered as a highly prospective customer in the automatic reply prohibited customer data 802c, and automatic reply is prohibited for the client.

Exceptional estimated price data 802e: In the case in which an estimated price calculated in a dealer individually is far from an estimated price which is usually automatically returned, for example, in the case in which an exceptionally low estimated price is presented due to various circumstances of a dealer (improvement of a sales state), the estimated price is stored in the exceptional estimated price data 802e as exceptional estimated price data.

Specification group data 802f: This data stores a specification group which should be retrieved when a dealer receives an estimation request and refers to the latest estimated price data 802a. That is, this data is used for judging to which specification group specification information received with the estimation request belong. Then, when the specification group is found using this data, the BTO server 1 retrieves an estimated price corresponding to the specification group of the latest estimated price data 802a.

For example, it is estimated that specifications for which estimation is requested are a base model A type+an engine B+a four-speed AT transmission+a tire C+an interior D type+an audio E type. Further, for example, it is assumed that a group defined by a combination of a base model, an engine, and a transmission is included in the specification group data 802f. In this case, the BTO server 1 retrieves the specification group data 802f from the received specification information, and a group X defined by the base model type A+the engine B+the four-speed AT transmission is derived. Then, next, the BTO server 1 checks for which of individual specification cars belonging to the group X an estimated price is stored in the latest estimated price data 802a. Then, if it is assumed that an estimated price of 2 million yen is stored as the latest estimated price data 802a for the base model A type+the engine B+the four-speed AT transmission+the tire C+the interior D type+an audio F type, only an audio type is different from that in the specification information for which estimation is requested. Thus, if a difference of the prices of the audios is assumed to be 20 thousand yen, the difference is added and an estimated price of 2 million and 20 thousand yen is automatically calculated and presented. In the case in which no estimated price is stored for the individual specification cars belonging to the group X at all, the dealer calculates an estimated price individually.

That is, the estimated price database stores an estimated price only for a part of the individual specification car. In the case in which an estimated price of the specification information received as the estimation request is not stored as latest estimated price data, the BTO server 1 reads an estimated price of specifications close to the specification information, corrects the read specification data, and sends it to the client terminal. Consequently, a storage capacity of the database can be reduced, and update of an estimated price is facilitated.

Estimatable minimum price data 802g: In this data, minimum prices allowed to be set to vehicles of respective specifications in the dealer are stored.

Automatic reply allowable value setting data 802h: This data is used for decision on whether or not to read an estimated price from the latest estimated price data 802a and send a reply automatically. In this data, an allowable price difference between an automatic reply estimated price and a market price, an allowable price difference between an automatic reply estimated price and a desired price with which a client desires to purchase a vehicle, and the like are stored.

Estimation returning salesclerk data 802i: In this data, salesclerks who sent a reply of estimation are stored in association with respective estimation requests.

Note that, although it is assumed here that the estimated price database 802 is prepared for each dealer, the present invention is not limited to this, and a system may be adopted in which the estimated price database 802 is prepared for each salesclerk of a dealer and each salesclerk can present a different estimated price to clients. In the case in which a client visits a shop (dealer) to have business talk, a salesclerk can present an estimated price which the salesclerk has determined personally. Therefore, if estimated prices are stored for each salesclerk, service can be provided to a client in a form close to a person-to-person sales form.

In addition, here, an estimated price which the dealer has calculated individually is stored in the latest estimated price data 802a and is deleted after a fixed period. Thus, estimated prices corresponding to all individual specification cars which clients can select are not stored. However, the present invention is not limited to this but may be constituted such that estimated prices corresponding to all individual specification cars are stored and reviewed in every fixed period.

In addition, although the BTO server 1 is managed by a manufacturer, estimated price data included in the estimated price database is never updated by the manufacturer and can be updated only by access from a dealer terminal. Therefore, the manufacturer cannot control an estimated price, and a dealer can set the estimated price independently.

Flow of Processing at the Time When Service is Used

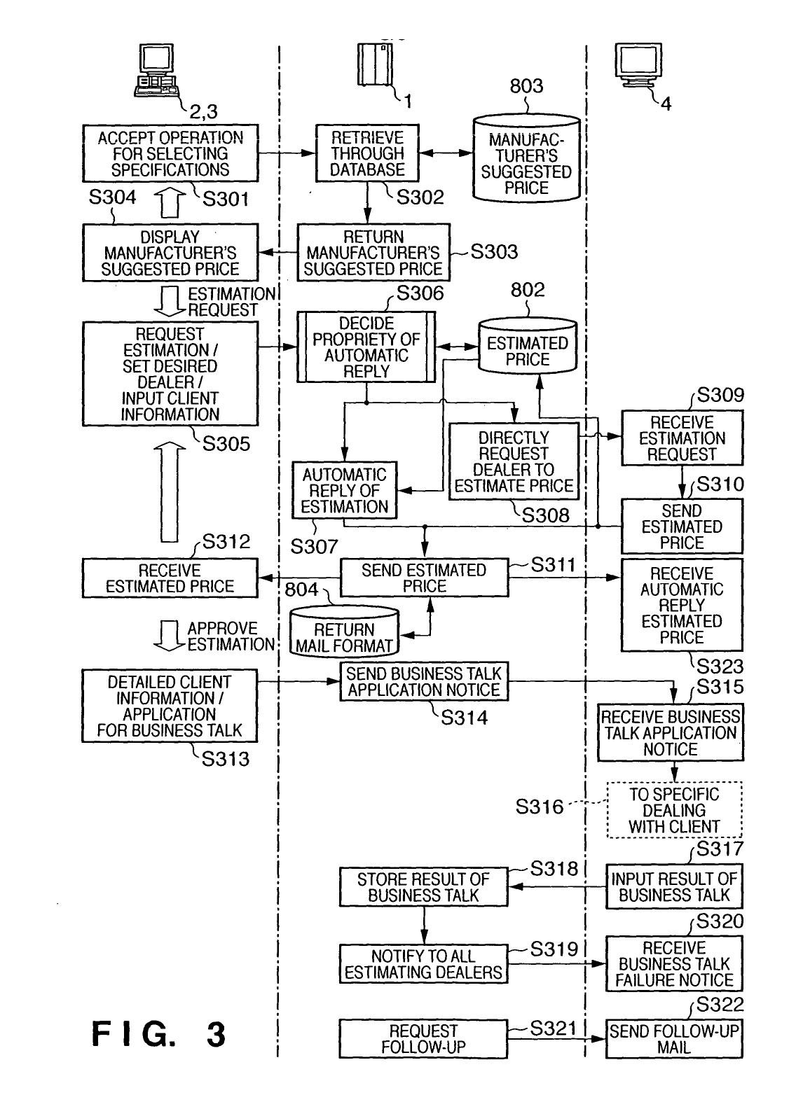

Next, a flow of service provision processing using this sales support system will be described with reference to FIGS. 3 to 8.

First, a client makes connection to the Internet using the desktop computer 2 or the PDA 3 serving as a client terminal to access a URL (e.g., HTTP://www.BTO.com) of the BTO server 1. In response to this, the BTO server 1 causes the client terminal to display Web contents prepared in advance.

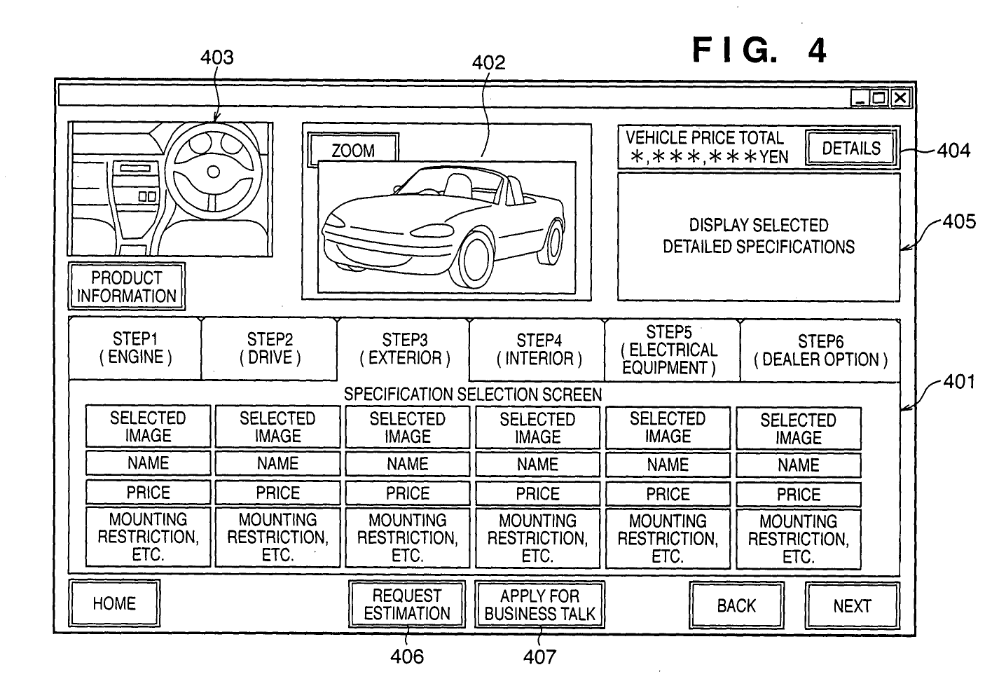

FIG. 4 is a diagram showing an example of a display screen of the Web contents. This screen is a screen on which specifications are set and a manufacturer's suggested price is displayed, and includes a specification selection field 401, an outward appearance display field 402 in which an outward appearance of a vehicle based upon selected specification is displayed, an interior display field 403, a manufacturer's suggested price display field 404, and a selected detailed specification list display field 405.

In the specification selection field 401, tabs are prepared for respective steps such that specifications can be determined through six steps consisting of a step 1 of selecting an engine, a step 2 of selecting a drive system (two-wheel drive, four-wheel drive, etc.), a step 3 of selecting an exterior, a step 4 of selecting an interior, a step 5 of selecting an electrical equipment system, and a step 6 of selecting a dealer option which is prepared for each dealer independently.

When a client selects the respective tabs to select an engine, a drive system, and the like in step S301, the information is sent to the BTO server 1. In step S302, the BTO server 1 reads an outward appearance image, an interior image, and a manufacturer's suggested price corresponding to the selection from the databases, respectively. Then, in step S303, the BTO server 1 returns information on the manufacturer's suggested price to the client terminal. Consequently, in step S304, the images, which are displayed in the outward appearance display field 402 and the interior display field 403, and the price in the manufacturer's suggested price display field 404, and the like are changed on the client terminal on a real time basis according to an operation for selecting specifications by the client.

That is, the client operates the client terminal to select specifications in a state in which the screen of FIG. 4 is displayed, whereby the reception of operation for selecting specifications (S301), the database retrieval (S302), the reply of manufacturer's suggested price (S303), the display of manufacturer's suggested price (S304) in FIG. 3 are performed repeatedly.

When information on selection of specifications is inputted from the client to some extent on the specification selection screen of FIG. 4, it becomes possible to select an estimation request button 406 and a business talk application button 407. In a normal procedure, the client selects the estimation request button 406 before selecting the business talk application button 407. When the estimation request button 406 has been selected and the BTO server 1 has received an estimation request; the BTO server 1 sends display data for displaying a dealer selection screen and a client information input screen to the client terminal, requests the client to select a dealer which calculates an estimated price, further requests input of simple client information, and saves the specification selection screen of FIG. 4, at the time when the estimation request button 406 is selected, in the BTO server 1.

Although the client information requested here is used for distinction of the client from other clients and does not always include an address and a real name, in this system, in order to return an estimated price with an electronic mail, the customer information includes at least an electronic mail address. However, the present invention is not limited to returning an estimated price with an electronic mail. That is, a method of providing an estimated price display field on the specification selection screen of FIG. 4 to display an estimated price in the field may be adopted. In that case, it is not necessary to request an electronic mail address as client information, and it is sufficient to request only a client ID for identifying the client in the BTO server 1. It goes without saying that a password or the like may be requested other than the client ID.

In addition, a desired price input column and a comment column further are prepared on the input screen for customer information. It is possible to input a price at which a client considers it appropriate to purchase a vehicle or make a comment on a dealer.

Further, varieties of information required to be inputted may be increased according to the number of times a client has requested estimation. For example, control may be performed such that, whereas estimation request for a first time is possible through input of an electronic mail address, in a second time of estimation request, the client information database 801 and the number of times of estimation database 802d are retrieved through at the point when the electronic mail address is inputted and, if it is found that the number of times of estimation request is twice or more and an address and a name have not been inputted, the estimation request button 406 cannot be selected unless further client information is inputted. This prevents the client from requesting estimation many times in vain and makes it possible to reduce load on the server and burden on the dealer.

Note that, before displaying the specification selection screen as shown in FIG. 4, the BTO server 1 may request the client to input the above-mentioned client information. In that case, simultaneously with the database retrieval processing S302, the BTO server 1 performs processing for registering the client information of the client in the client information database 801.

When the dealer is selected and the client information is inputted in the client terminal in step S305 of FIG. 3, the information is sent to the BTO server 1, and the BTO server 1 decides in step S306 whether or not an estimated price may be automatically returned based upon the received specification information and client information and the estimated price database 802.

If it is decided that an estimated price may be returned automatically, the BTO server 1 proceeds to step S307 and reads an estimated price from the estimated price database 802 using the specification information. Then, the BTO server 1 proceeds to step S311, and embeds the estimated price read from the estimated price database 802 in a template of an electronic mail read from the return mail format database 804 and sends it to the client terminal. At the same time, the BTO server 1 notifies the dealer what kind of estimated price is automatically returned to which client (S323).

On the other hand, if it is decided that the estimated price should not be automatically returned, the BTO server 1 proceeds to step S308, and sends the specification information and the client information to the dealer terminal 4 to request calculation of individual estimation. Note that, in this embodiment, the BTO server 1 requests a dealer to estimate a price with an electronic mail sent to the dealer.

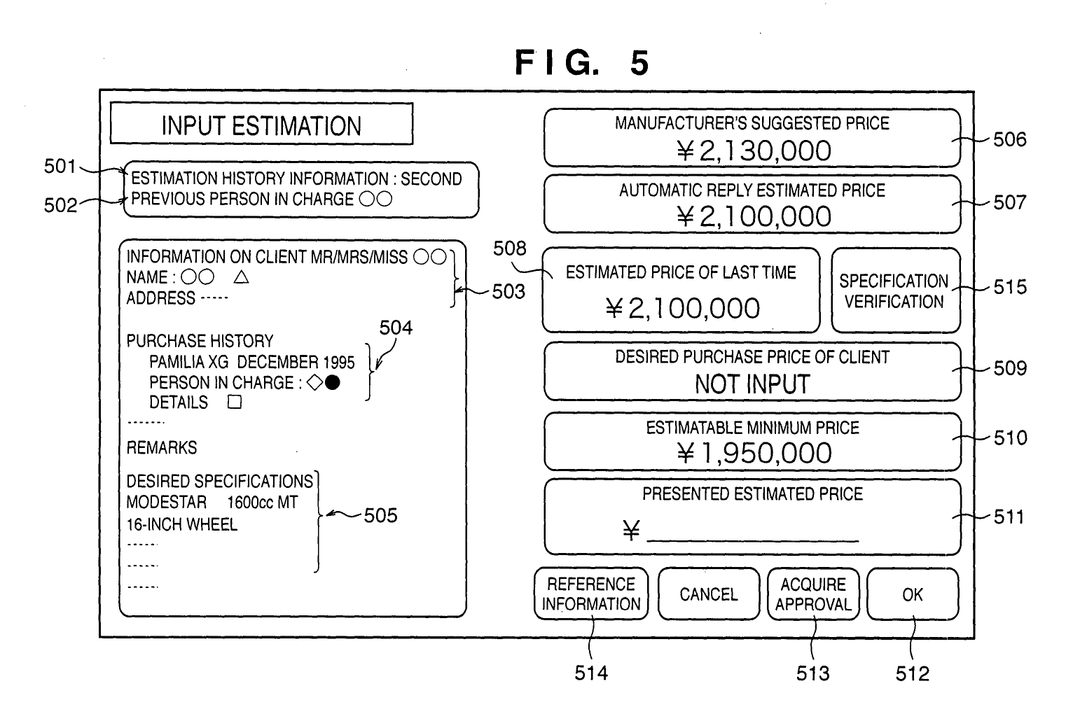

The BTO server 1 has Web contents for allowing a dealer to input an estimated price and embeds a URL for accessing a page of the Web contents in an estimation request mail. That is, a URL for inputting estimation is embedded in the estimation request mail sent to the dealer and, when a person in charge of estimation of the dealer receives the estimation request mail and opens the mail to select the URL in step S309, the Web browser of the dealer terminal 4 accesses Web contents corresponding to the estimation request in the BTO server 1. As a result, a screen as shown in FIG. 5 is displayed on a display of the dealer terminal 4.

FIG. 5 is a diagram showing an example of the screen for inputting estimation. As shown in FIG. 5, on the screen for inputting estimation, the number of times of estimation request 501 of the client, a name of the previous person in charge of estimation 502, client information 503, a vehicle purchase history 504 of the client, specification information 505 for which estimation is desired, a manufacturer's suggested price 506 with the specifications, an estimated price for automatic reply 507, an estimated price presented last time 508, a desired purchase price 509 inputted by the client, an estimatable minimum price 510, an estimated price input column 511 are indicated as information to be references in calculating an estimated price.

Consequently, for example, if the dealer refers to the number of times of estimation request 501, the dealer can judge whether presentation of estimation to the client is first presentation or second presentation. In addition, if the dealer refers to the estimated price presented last time 508 for the identical client, the dealer can grasp an upper limit of an estimated price which can be presented this time. This is because it is extremely insincere to present an estimated price higher than that of the last time to the identical client, which may lead to loss of confidence of the client. That is, the estimated price presented last time 508 functions as means for regulating an estimated price for a salesclerk.

In addition, a specification verification button 515 is provided on the right of the estimated price presented last time 508. When the specification verification button 515 is selected, a difference of specifications between specifications, which were targets of the estimation request of the last time, and specifications to be targets of estimation request of this time is sent from the BTO server 1 and displayed on the dealer terminal. It goes without saying that only the information on specifications, which were targets of the estimation of the last time, may be displayed to cause the salesclerk to compare the information on specifications to be targets of estimation of this time. If there is a difference of specifications, by taking into account the difference together with the estimated price presented last time 508, the salesclerk can calculate an estimated price prudently such that an improperly high estimated price is not presented this time.

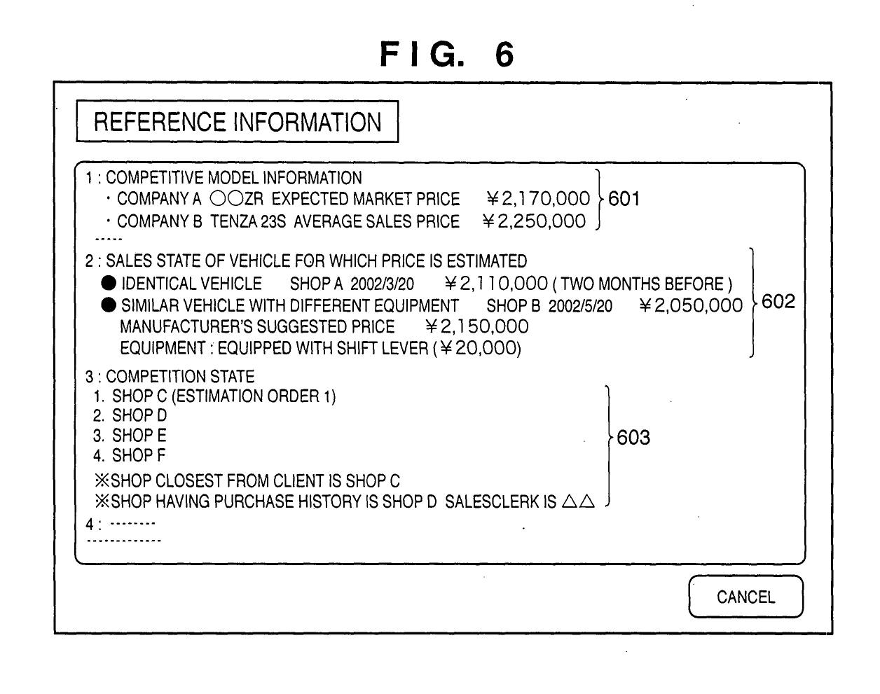

When a reference information button 514 is selected on the page of FIG. 5, a reference information screen shown in FIG. 6 is displayed. As reference information, competitive model information 601, a successful bid state 602 of a vehicle for which estimation is made, competition information 603 for a present client, and the like are read from the reference information database 805 and sent to the dealer terminal to be displayed.

The competition information 603 indicates what kind of shops the client has requested to estimate a price. Shops indicated here are shops sharing the same BTO system and include shops which have not presented estimation yet.

The competition information 603 also indicates a shop closest to an address of the client, a shop where the client has purchased a vehicle, and a shop which has presented service to the client among the shops which are request to estimate a price, a salesclerk who is on friendly terms with the client, and the like. Note that it goes without saying that these pieces of information are displayed in the case in which a client is specified completely, and the competition information 603 is not displayed at a stage when essential information such as a name and an address are not inputted.

In addition, the shops indicated in this competition information 603 are allocated a priority based upon predetermined criteria. The priority is indicated by allocating numbers 1 to n in order from a shop which is most desirable for selling a vehicle. However, this priority is not an absolute one and is simply a standard to the end. For example, the shops may be simply arranged in order from one in close distance from the address of the client or may be simply arranged in an order in which the client has requested estimation. That is, although a shop C is indicated as a shop with a first order of estimation in the competition information 603 of FIG. 6, this does not means that the shop C always has to present a lowest estimated price but simply means that it is desirable for the client that the shop C estimates a lowest price because the shop C is closest to the address of the client.

As described above, a salesclerk of a dealer can obtain information useful for calculating an estimated price from the screens of FIGS. 5 and 6.

The estimated price calculated by the salesclerk is, in principle, stored in the estimated price database 802 as the latest estimated price data 802a. Consequently, it is necessary to urge the salesclerk to calculate an estimated price carefully so as not to present a low estimated price recklessly. The reference information shown in FIGS. 5 and 6 can contribute to such careful calculation of an estimated price and prevent the latest estimated price data 802a from declining at an improper pace.

An estimated price is calculated individually from the reference information and inputted in the input column 511 of FIG. 5. When an OK button 512 is selected, the estimated price is sent to the BTO server 1 in step S310 of FIG. 3.

The BTO server 1 judges whether or not the received estimated price is a proper one and, if it is judged improper, sends warning to the dealer terminal to seek approval before proceeding to step S311. More specifically, the BTO server 1 compares the estimated price presented to the same client last time and the received estimated price taking into account a difference of specifications and judges whether the received estimated price is too high. In the case in which there is no difference of specifications between the estimation request of the last time and the estimation request of this time, the BTO server 1 judges that received estimated price is improper if it is higher than the estimated price of the last time. In addition, in the case in which there is a difference of specifications, the BTO server 1 calculates an estimated price found by taking into account the difference of specifications and judges that the estimated price is improper if the estimated price to be presented this time is higher than the estimated price. In addition, the BTO server 1 also judges that the estimated price is improper if a price lower than a predetermined minimum price is received.

When an approval acquisition button 513 is selected, a not-shown approval acquisition screen is displayed and, after a predetermined password is inputted on the screen, the BTO server 1 decides that any estimated price inputted in the input column 511 is proper and proceeds to step S311.

Here, the estimatable minimum price 510 is a minimum price which is allowed to be set for a vehicle of the specifications in the dealer. This is stored in the estimated price database 802 and is protected such that it can only be updated by specific people of the dealer. Consequently, the BTO server 1 prevents the salesclerk of the dealer from selling a vehicle at an unreasonably low price without permission and presenting a price higher than an estimated price of the last time as estimation.

In FIG. 5, the input column 511 is blank. However, a recommended estimated price, which is derived from the estimated price presented last time and the difference of specifications between the estimation of the last time and the estimation of this time, may be inputted and displayed in the input column 511 at the point of display of FIG. 5. Consequently, decision of an estimated price by the salesclerk is facilitated. In addition, in the case in which estimation is requested a predetermined number of times or more by the same client, the BTO server 1 may perform control such that an amount equal to or lower than the estimated price presented last time cannot be inputted in the input column 511. Consequently, the BTO server 1 can prevent an estimated price from continuously declining every time the client requests estimation.

In addition, it is also possible to arrange such that a person other than the previous person in charge of estimation cannot input an estimated price in the input column 511. For example, it is sufficient to register IDs and passwords of persons in charge of estimation of a shop are registered in advance in the BTO server 1 and, if an ID and a password of the previous person in charge of estimation 502 are not inputted, not to allow the input column 511 to be changed. Such control of input to the input column 511 is made possible by a JAVA (registered trademark) script, a CGI program, or a plug-in prepared in the BTO server 1. Since it is already publicly known to control input of data to Web contents using the CGI program or the plug-in, specific contents of the program are omitted here.

When it is decided in step S310 that the estimated price inputted to the input column 511 is proper, the BTO server 1 further performs processing for storing this estimated price in the estimated price database. More specifically, the BTO server 1 sends data of a screen for selecting in what kind of form the estimated price is saved in the estimated price database 802 to the dealer terminal 4, and causes the dealer terminal 4 to display such a screen. By operating the dealer terminal 4 in that state, the person in charge of estimation of the dealer can decide whether an estimated price calculated and returned individually is saved as latest automatic return estimated price data or as exceptional estimated price data. Consequently, the estimated price for automatic reply stored in the estimated price database can be updated at an appropriate opportunity, and an appropriate estimated price can be presented without excessive burden on the dealer. In addition, since the dealer terminal is inquired whether or not to overwrite the estimated price for automatic reply stored in the estimated price database, an improper estimated price can be prevented from being stored as the estimated price for automatic reply. That is, the dealer terminal can sufficiently obtain an opportunity for updating the estimated price for automatic reply can be obtained sufficiently, and can perform control such that a proper estimated price is automatically sent.

For example, in the case in which the estimated price is calculated individually in the dealer and, then, stored as an estimated price to be returned automatically, it is saved as latest automatic return estimated price data. On the other hand, in the case in which the estimated price calculated in the dealer individually is far from the estimated price which is automatically returned usually, it is saves as exceptional estimated price data, and the estimated price for automatic reply is not updated. That is, the exceptionally calculated estimated price is saved separately from the estimated price for automatic reply, the estimated price for automatic reply never declines excessively, and proper estimation can be presented.

Here, in the case in which it is decided that the estimated price is saved as the automatic reply estimated price data, authentication by a representative of the dealer is necessary. That is, a screen for inputting an ID and a password of the representative is further displayed and, if the ID and the password are not inputted, the estimated price can only be saved as exceptional estimated price data. Consequently, if the dealer adopts a management system in which only a predetermined acknowledger knows an approval ID of the acknowledger, a salesclerk in the dealer cannot overwrite a database without permission, and an estimated price for automatic reply can be controlled more strictly.

In addition, when the estimated price for automatic reply is overwritten, an estimated price before update is stored in the estimated price history data 802b as a history. That is, when the estimated price for automatic reply is overwritten, since an estimated price in the past is left in a database, a history of changing estimated prices can be easily grasped. Such a history of change can be used as reference information in judging how the estimated price for automatic reply should be updated, and the dealer can easily update the estimated price for automatic reply. Eventually, a desire to purchase of a client can be aroused by flexible update of an estimated price.

Note that, although the person in charge of estimation in the dealer is urged to select an estimated price by displaying the selection screen here, the BTO server 1 may select an estimated price automatically. For example, the BTO server 1 may perform control to decide whether or not a difference between an inputted estimated price and an estimated price for automatic reply is within a predetermined range and, if the difference is within the predetermined range, save the estimated price as estimated price data for automatic reply.

In addition, it goes without saying that latest estimated price data of an estimated price database can be updated also by a direct estimated price update operation from a dealer terminal. That is, estimated price update processing can be performed directly from the dealer terminal even in the case in which estimation is not requested by a client. Consequently, since a salesclerk of the dealer can update the database appropriately, desire to purchase of the client can be aroused by flexible update of the estimated price.

Next, in step S311, the BTO server 1 prepares an electronic mail incorporating the received proper estimated price and sends an estimated price presentation mail to the client terminal.

Upon acquiring an estimated price to be presented to the client terminal, the BTO server 1 generates a screen, which is created by further adding an estimated price display field and a dealer display field to the specification selection screen of FIG. 4 at the time when the estimation request button 406 was selected, and assigns a peculiar URL to it. Then, the BTO server 1 embeds this peculiar URL in the estimated price presentation mail to be sent to the client terminal.

Note that, the dealer terminal may prepare a comment which should be described in the estimated price presentation mail. In that case, in step S310, the comment is sent to the BTO server 1 from the dealer terminal. Consequently, an estimated price presentation mail of contents according to a client can be sent to the client terminal, and a relation between the dealer and the client can be made closer.

The client terminal receives the estimated price presentation mail in step S312. If the client terminal accesses the URL embedded in the mail, the specification selection screen of FIG. 4 at the point when the estimation request button 406 was selected with the addition of the dealer and the estimated price in the dealer can be displayed on the browser. Therefore, if the client is dissatisfied with the estimated price presented by the estimated price mail, the client only has to return to step S301 and reexamine the specifications by operating the specification selection field 401 or proceed to step S305 by pressing the estimation request button 406 again and request another dealer to estimate a price. It goes without saying that the client may request the same dealer to estimate a price again. On the other hand, if the client is satisfied with the estimated price presented by the estimated price mail, the client only has to select the business talk application button on the screen of FIG. 4.

When the business talk application button 407 is selected on the screen of FIG. 4 in step S313, the BTO server 1 sends a screen for inputting detailed client information to the client terminal and, client information inputted thereto is sent to the BTO server 1 together with the specification information, the dealer information, and the estimated price.

Upon accepting an application for business talk, the BTO server 1 stores which client has applied for business talk to which dealer at what kind of estimated price. Further, in step S314, the BTO server 1 sends a business talk application notice including the detailed client information, specification information, and estimated price to a dealer to which business talk are applied. Note that each business talk application notice is assigned a business talk number for identifying the business talk.

The dealer which has received the business talk application notice in step S315 proceeds to step S316 and starts specific business talk with the client. In step S316, for example, exchange of information such as a method of payment of charges and a date of delivery, and a trade-in price of a vehicle is performed between the salesclerk and the client using an electronic mail or directly. Finally, the client pays the charges in step S311 and the dealer delivers an individual specification car as a vehicle, whereby the business talk ends.

In step S317, the dealer having concluded the business talk accesses the BTO server 1 with the dealer terminal 4 to input a business talk result. Here, the dealer only has to input the business talk number assigned to the business talk application notice and a final sales amount as the business talk result.

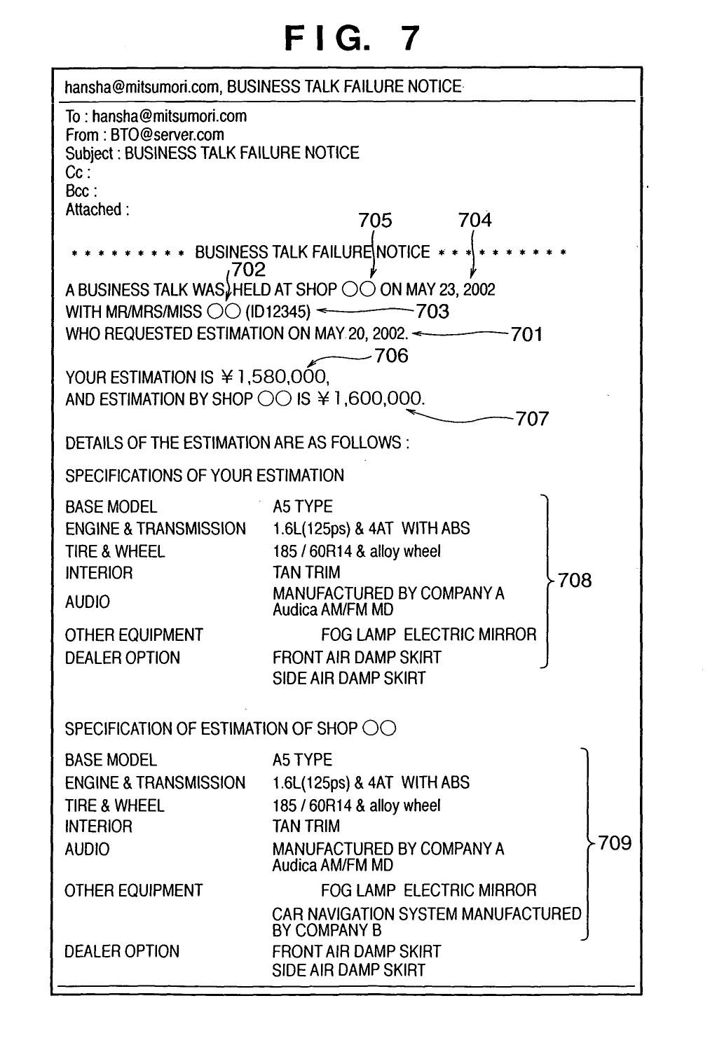

The BTO server 1 stores the business talk result in step S318 and further proceeds to step S319 to notify all dealers, which have estimated prices, of the result (information on conclusion of the business talk). This notice is sent by an electronic mail with contents as shown in FIG. 7. That is, a date of request for estimation 701, a client name 702, a client ID 703, a date of conclusion of business talk 704, a name of dealer having concluded business talk 705, an estimate price which was presented by a dealer having received electronic mail 706, an estimated price presented by the dealer having concluded business talk 707, specifications for which price is estimated by dealer having received electronic mail 708, and specifications for which price is estimated by the dealer having concluded business talk 709 are notified to all the dealers which could not have business talk with the client. Here, a title of this electronic mail is set as “business talk failure notice” because it indicates that the business talk has failed for a dealer which has received the electronic mail. That is, business talk conclusion information for a first dealer may be a business talk failure notice for a second dealer. Note that information indicating a state of sales of the dealer having concluded business talk may be included in this business talk failure notice in addition to the above-described items.

Upon receiving such a business talk failure notice in the dealer terminal 4 in step S320, each dealer can obtain information to be a reference in updating an estimated price database such as information on how high estimation by the dealer was compared with estimation of other dealers or information at which estimated price the client determined to purchase a vehicle from the dealer.

Note that it is desirable that a URL for accessing a page for changing an estimated price for automatic reply of the dealer is embedded in the electronic mail shown in FIG. 7. Then, the dealer can immediately reflect an estimated price which is based upon the electronic mail on a database.

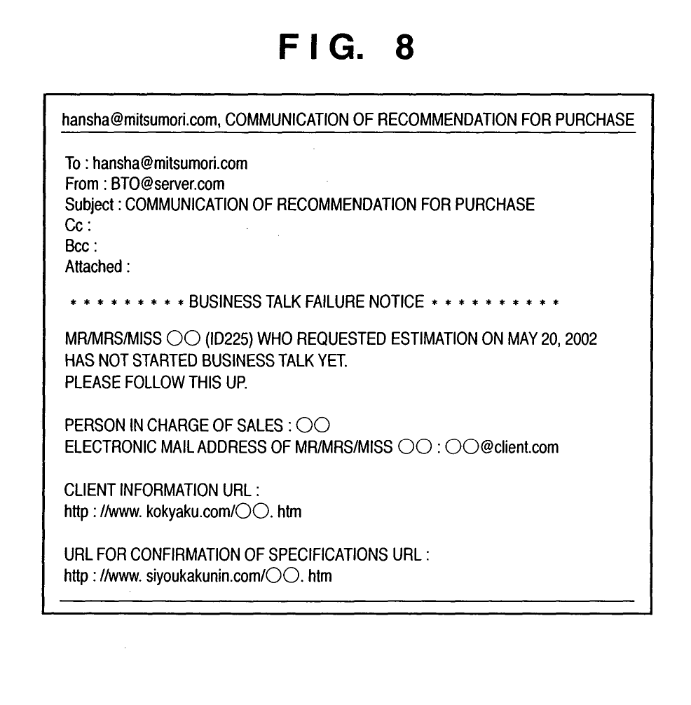

In addition, in the case in which the client who requested estimation has not started business talk with any dealer, in step S321, the BTO server 1 sends a follow-up request mail shown in FIG. 8 to each dealer (or only a prioritized dealer). The follow-up request mail is an electronic mail for requesting a dealer to confirm a desire to purchase of a customer who requested estimation. As shown in the figure, in this follow-up mail, in addition to a name of a person in charge of estimation of the dealer, an electronic mail address of the client, and the like, a URL of a page on which information about the client is displayed and a URL of a page on which specification information for which the client has requested estimation are embedded.

The BTO server 1 is programmed to count the number of days from last estimated price transmission processing and, when a predetermined period such as one month has elapsed without receiving any business talk application or information on business talk conclusion, to automatically send a follow-up request mail.

In the case in which the follow-up request mail of FIG. 8 is received by the dealer terminal 4, the person in charge of estimation of the dealer judges whether or not follow-up is necessary for the client and, if the follow-up is necessary, encourages the client to purchase a vehicle by, for example; sending a follow-up mail (mail for confirming desire to purchase of a client who requested estimation) directly to the client.

Note that, in the case in which the BTO server 1 counts the number of days from last estimated price transmission processing and the predetermined period has elapsed without any receipt of business talk application or information on business talk conclusion, a follow-up mail may be sent to the client automatically.

Decision on Propriety of Automatic Reply of Estimation

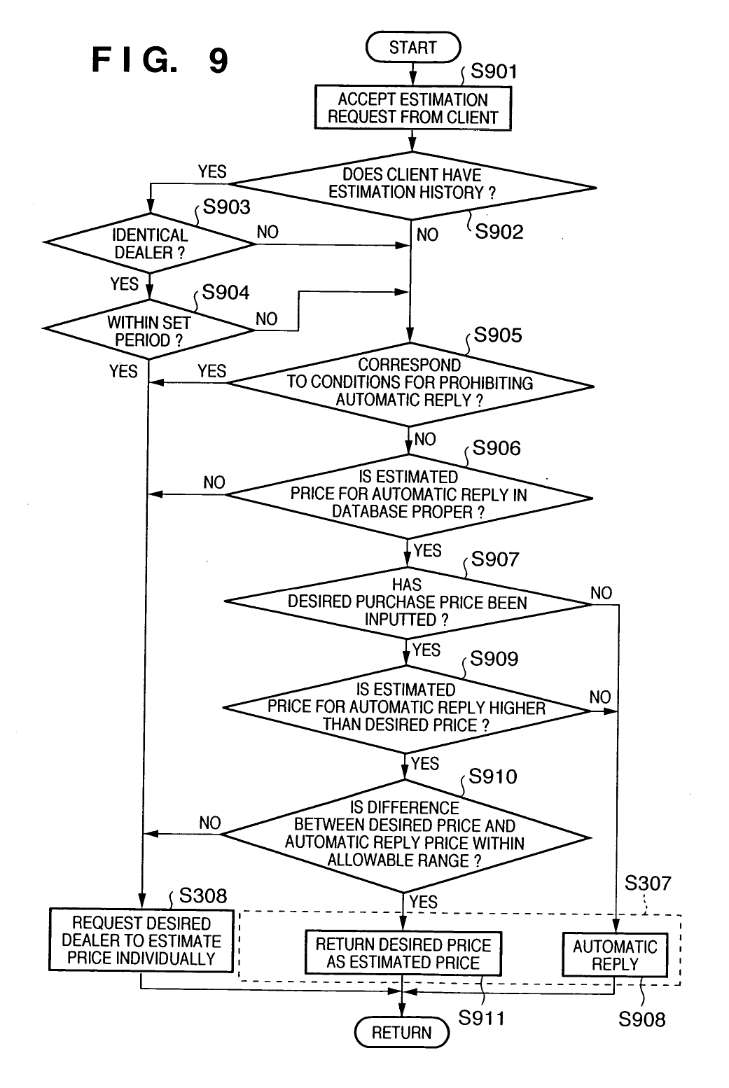

Next, contents of decision in step S306 of FIG. 3 will be described in detail with reference to FIG. 9.

First, upon receiving specification information and client information as well as an estimation request from the client terminal in step S901, the BTO server 1 proceeds to step S902, retrieves through a database using the client information included in the estimation request, and decides whether or not the client has an estimation history. If there is an estimation history, the BTO server 1 proceeds to step S903 and further decides whether or not an estimation request remaining as a history is an estimation request for a dealer which is identical with the dealer which is a target of the estimation request of this time. If the estimation request is an estimation request for the identical dealer, the BTO server 1 further proceeds to step S904 and decides whether or not the estimation request is made within a predetermined period from the estimation request of the last time. If it is decided in step S904 that the estimation request is made within the predetermined period from the estimation request of the last time, the BTO server 1 proceeds to step S308, sends the specification information and the client information to the dealer terminal 4, and request calculation of individual estimation.

If it is found by the decision that the client has requested the same dealer to estimate a price many times within a predetermined period, it becomes possible to perform individual estimation for the client judging that the client is a client having a strong desire to purchase. Consequently, the dealer can deal with the client with a strong desire to purchase more carefully. Note that processing for deciding whether or not an estimation request is one for the same specifications and processing for deciding whether the estimation request has been made a predetermined number of times (three times, four times, etc.) or more may be inserted between step S904 and step S308 to judge that a client who has requested the same dealer to estimate a price many times for the same specification is a client aiming to lower an estimated price and automatically return an estimated price to the client.

In the case in which there is no estimation history, the case in which, even if there is an estimation history, it is not for an identical dealer, or the case in which a predetermined period or more has elapsed from estimation of the last time, the BTO server 1 proceeds to step S905 and performs verification of conditions for prohibiting automatic reply.

In this verification of conditions for prohibiting automatic reply, the BTO server 1 refers to the automatic reply prohibited client data 802c and decides whether or not the client is stored as a client for whom automatic reply should not be performed. Consequently, careful presentation of estimation can be performed for a client, who can be judged as a highly prospective customer, having strong desire to purchase, such as a good customer, and the customer can be treated differently from a client who has requested estimation just out of curiosity. In addition, whether or not the client is stored as a client for whom automatic reply should not be performed is also decided according to whether or not a comment of the client is included in estimation request data from the client. Consequently, considering that a client who has requested estimation with a comment is a client with strong desire to purchase, the customer can be treated more carefully. To the contrary, since it is relatively less likely that a client with no comment has strong desire to purchase, an estimated price can be presented to the client by automatic reply to reduce burden on the dealer.

If the client is stored in the automatic reply prohibited client data 802c or if a comment is included in the estimation request data, the BTO server 1 proceeds to step S308, and sends the specification information and the customer information to the dealer terminal 4 to request calculation of individual estimation.

If the client does not correspond to the conditions for prohibiting automatic reply, the BTO server 1 proceeds to step S906 and refers to the latest estimation price data 802a based upon specification information. Then, the BTO server 1 decides whether or not a predetermined period has elapsed form update of an estimated price in the database 802 and, if the predetermined period has elapsed, the BTO server 1 proceeds to step S308.

That is, the BTO server 1 retrieves an estimated price corresponding to the specifications, for which estimation request has been received, from the estimated price stored in the latest estimated price data 802a, reads when the estimated price was updated and, if the date of update is, for example, six months or more before a date of returning estimation, judges that the estimated price is too old to be automatically returned, and performed individual estimation.

Next, in step S906, the BTO server 1 decides whether or not an estimated price to be automatically transmitted corresponding to the specification information is stored as the latest estimated price data 802a and, if the estimated price to be automatically transmitted is not stored, proceeds to step S308.

Moreover, in step S906, the BTO server 1 refers to the market price database 806, decides whether or not the estimated price read from the latest estimated price data 802a is far from a market price and, if the estimated price is far from the market price, proceeds to step S308. That is, the BTO server 1 reads a market price of a model to be a target of comparison from the market price database 806 using the specification information, compares the market price with the estimated price of the latest estimated price data 802a, and decides whether or not the difference is within an allowable range. If the difference exceeds the allowable range, the BTO server 1 judges that the estimated price of the latest estimated price data 802 is not suitable for automatic reply, and performs individual estimation.

According to the above-described decisions, the BTO server 1 judges whether or not the estimated price for automatic reply in the database is proper and, if it is judged that the estimated price is proper, proceeds to step S907, and decides whether or not a desired purchase price has been inputted by the client. If a desired purchase prices has not been inputted, the BTO server 1 proceeds to step S908 and presents the estimated price for automatic reply read from the database to the client with an electronic mail.

In the case in which a desired price has been inputted, the BTO server 1 proceeds to step S909 and decides which of the desired price and the estimated price for automatic reply is higher. If the estimated price for automatic reply is lower than the desired price, since there is no problem, the BTO server 1 proceeds to step S908 and presents the estimated price for automatic reply read from the database to the client with an electronic mail.

If it is judged in step S909 that the estimated price for automatic reply is higher than the desired price, the BTO server 1 proceeds to step S910, calculate a difference of the prices, and decides whether or not the difference of the prices is within a predetermined range. If the difference of the prices is not within the predetermined range, since this means that the estimated price for automatic reply is a high price far from the desired price of the client, the BTO server 1 judges automatic reply will cause a large problem, and proceeds to step S308 to perform individual estimation.

If the difference of the prices in step S910 is within the predetermined range, since it is possible that a desire to purchase of the client increases when an estimated prices as desired is presented, the BTO server 1 proceeds to step S911, and presents the same price as the desired price as an estimated price.

Effects of this Embodiment

As described above, according to the sales support system in accordance with this embodiment, abundant materials for updating an estimated price can be obtained, and the estimated price can be updated flexibly. In addition, since an opinion or the like from the client mentioning that the estimated price is too high can be reflected on an estimated price, it becomes possible for the client to enjoy price negotiation at the time of purchasing a vehicle. Moreover, since salesclerks of a dealer do not always calculate estimated prices for all clients one by one but perform automatic reply appropriately, business processing in the dealer does not become complicated. Consequently, high quality service can be provided taking into account a balance between the business processing of the dealer and a desired of a customer.

More specifically, the sales support system decides whether to read an estimated price automatically from a database and presents the estimated price to the client or to inquire an estimated price from the dealer directly, appropriate estimation can be presented without applying excessive burden to the dealer.

That is, basically, the dealer presents an estimated price taking into account a response from the client for each estimation request from the client. However, for example, if an estimated price satisfies various conditions, for example, an estimated price stored in an estimation database is not far from a market price, since the sales support system can read the estimated price and present it to the client automatically, burden on the dealer caused by performing examination of estimation can be reduced.

In addition, since the sales support system confirms with the dealer whether or not the estimated price read from the estimated price database automatically may be presented to the client, an estimated price against the dealer's wishes can be prevented from being presented to the client and, since the dealer only has to input whether or not the dealer approves the estimated price, burden on the dealer can be reduced compared with the case in which estimation is calculated for all estimation request one by one.

In addition, since the sales support system automatically sends an estimated price of the estimated price database to the client terminal in response to estimation request which is received within a predetermined period from update of the estimated price database, a highly reliable estimated price can be automatically presented to a client.

Moreover, since the sales support system automatically presents an estimated price taking a market price into account, the estimated price to be automatically presented can be set to a proper amount without presenting a preposterous estimated price far from the market price. Note that if an estimated price significantly different from the market price is stored in the estimated price database, the estimated price only has to be updated after confirmation with the dealer.

In addition, since the sales support system presents an estimated price corresponding to a desired price presented from the client, a proper estimated price can be presented without damaging the client's impression. If an estimated price of the database is slightly higher than the desired price, the estimated price of the database can be presented to the client to persuade the client. If a difference between the desired price and the estimated price is set in a range which does not affect a desire to purchase of the client, the client is encouraged to purchase a vehicle without decreasing the estimated price.

In addition, if an estimated price of the database is slightly higher than a desired price, the client can be satisfied by directly presenting the desired price as an estimated price. If the difference between the desired price and the estimated price is set in a range which does not affect a profit of the dealer significantly, the client can be satisfied by a slight discount of the estimated price. In addition, in this case, if an estimated price stored in the database is not updated, the estimated price stored in the database can be prevented from decreasing endlessly.

Further, in the case in which a desired price is higher than an estimated price of the database, since the desired price is presented to the client, both of the client and the dealer can be satisfied.

The sales support server can store estimated prices different for each salesclerk of the dealer in the database. Therefore, each salesclerk can present a different estimated price to the client at his/her own discretion, and the estimated price can be presented in a form more similar to a person-to-person sales method.

Since the sales support server stores estimated prices for all specifications of a vehicle in the estimated price database, an estimated price complying with specifications as requested by the client can be read from the estimated price database, and an accurate estimated price can be sent simply.

Since the sales support server stores estimated prices for specifications of a part of a vehicle in the estimated price database, an estimated price close to specifications requested by the client can be read with a small storage capacity, and update of an estimated price stored in the database is also facilitated. Then, in the sales support server, since the read estimated price is corrected by an amount equivalent to deviation of the specifications, an accurate estimated price can be presented.

Although the sales support server is managed by a manufacturer, estimated price data included in the estimated price database is never updated by the manufacturer but can be updated only by access from the dealer terminal. Therefore, the manufacturer cannot control an estimated price, and the dealer can set an estimated price independently.

In addition, according to the above-mentioned embodiment, a high quality service can be presented taking into account a balance between business processing of the dealer and a desire of the client. In particular, since the sales support system has an automatic reply prohibiting conditions setting function which, in selecting automatic reply and individual reply of an estimated price, prohibits the automatic reply if the client meets exceptional conditions even if the automatic reply is possible, a vehicle can be sold in a form closer to a person-to-person vehicle sales form.

That is, since the sales support system decides whether to automatically send an estimated price stored in the estimated price database to the client terminal or to inquire an estimated price from the dealer according to client information, a method of presenting an estimated price suitable for the client can be selected.

Therefore, an appropriate estimated price can be presented without applying excessive burden to the dealer.

In addition, the sales support system can refer to automatic reply prohibited client data in which clients to whom an estimated price should not be automatically sent are registered. Then, if a client who has requested estimation is included in the automatic reply prohibited client data, the sales support system inquires an estimated price from the dealer.

Consequently, an estimated price can be presented carefully to a client who is judged as a highly prospective customer, having strong desire to purchase, such as a good customer, and the customer can be treated differently from a client who has requested estimation just out of curiosity.

In addition, the sales support system can refer to number of times estimation data, in which the number of times estimation has been requested, for each client. Then, in the case in which a client who has requested estimation requested estimation in the past predetermined number of times or more, the sales support system inquires an estimated price from the dealer.

Consequently, the sales support system can deal with the client who requested estimation in the past more carefully considering that the client is a client having a strong desire to purchase. Conversely, the sales support system can present an estimated price by automatic reply to a client who did not request estimation in the past for the time being, thereby reducing a burden on the dealer.

In addition, the sales support system is capable of receiving a comment from a client and, if a comment is received from a client, inquires an estimated price from the dealer. Consequently, the sales support system can deal with a client who has requested estimation with a comment more carefully considering that the client is a client having a strong desire to purchase. Conversely, since a client who has not made a comment is relatively less likely to have a strong desire to purchase, the sales support system can present an estimated price by automatic reply, thereby reducing burden on the dealer.

Further, in the case in which a first calculator who has asked to calculate an estimate price by a client and a second calculator of an estimated price stored in the estimated price database are different, since the sales support system seeks approval of the dealer, automatic transmission of an estimated price can be performed more carefully.

Other Embodiments

Note that the present invention can also be attained by the CPU of the BTO server 1 reading a program, which is capable of realizing the processing described in FIGS. 3 and 9, from some storage medium to execute the program. In this case, as the storage medium, in addition to a read-writable semiconductor memory or hard disk, any storage device such as an optical disk, a magnetic disk, or a magneto-optical disk can be adopted. Such a storage medium or a program itself is included in the scope of the present invention. Therefore, data to be transmitted through a telecommunication line by using the Internet or the like can also be included in the scope of the present invention.

As many apparently widely different embodiments of the present invention can be made without departing from the spirit and scope thereof, it is to be understood that the invention is not limited to the specific embodiments thereof except as defined in the appended claims.

What is claimed is:

1. A sales support server which is capable of communicating with an estimated price database, in which specifications for vehicles and estimated prices to be automatically transmitted of the vehicles are stored in association with each other for a plurality of kinds of vehicles, a dealer terminal used by a dealer of vehicles, and a client terminal each other via a network, the sales support server comprising:
a reception unit which receives specification information specifying specifications for a vehicle and an estimation request from said client terminal;
a reading unit which reads an estimated price to be automatically transmitted from said estimated price database based upon the specification information;
a first transmission unit which sends the estimated price to be automatically transmitted read by said reading unit to said client terminal;
a second transmission unit which sends the specification information received by said reception unit to said dealer terminal in order to inquire an estimated price from said dealer; and
a control unit which, when the estimation request is received by said reception unit, decides whether to send the estimated price to be automatically transmitted stored in said estimated price database to said client terminal or to inquire the estimated price from said dealer, and controls said first transmission unit or said second transmission unit.

2. The sales support server according to claim 1, further comprising a confirmation unit which confirms with said terminal apparatus whether or not the estimated price to be automatically transmitted read by said reading unit may be presented to a client,
wherein, according to a result of confirmation by said confirmation unit, the estimated price to be automatically transmitted is sent to said client terminal by said first transmission unit.

3. The sales support server according to claim 1,
wherein, in response to an estimation request which is received within a predetermined period from update of the estimated price to be automatically transmitted in said estimated price database, said control unit controls said first transmission unit to send the estimated price to be automatically transmitted stored in said estimated price database to said client terminal.

4. The sale support server according to claim 1,
wherein said sales support server is capable of communicating with a price information database which stores a market price relating to the vehicle, and
said control unit uses the specification information received by said reception unit to read a related market price from said price information database and read an estimated price to be automatically transmitted from said estimated price database and, in the case in which a difference between the read estimated price to be automatically transmitted and the market price is within a predetermined range, controls said first transmission unit to send the estimated price to be automatically transmitted stored in said estimated price database to said client terminal.

5. The sales support server according to claim 1,
wherein said reception unit further receives a desired price at which a client desires to purchase a vehicle from said client terminal, and
in the case in which the estimated price to be automatically transmitted read from said estimated price database is higher than the desired price received by said reception unit, if a difference between the estimated price to be automatically transmitted and the desired price is within a predetermined range, said control unit controls said first transmission unit to send the read estimated price to said client terminal.

6. The sales support server according to claim 1,
wherein said reception unit further receives a desired price at which a client desires to purchase a vehicle from said client terminal, and
in the case in which the estimated price to be automatically transmitted read from said estimated price database is higher than the desired price received by said reception unit, if a difference between the estimated price to be automatically transmitted and the desired price is within a predetermined range, said control unit controls said first transmission unit to send the received desired price to said client terminal as an estimated price.

7. The sales support server according to claim 1,
wherein said reception unit further receives a desired price at which a client desires to purchase a vehicle from said client terminal, and
in the case in which the desired price received by said reception unit is higher than the estimated price to be automatically transmitted read from said estimated price database, said control unit controls said first transmission unit to send the received desired price to said client terminal as an estimated price.

8. The sales support server according to claim 1,
wherein said estimated price database stores the estimated price to be automatically transmitted for each salesclerk of said dealer,
said reception unit further receives salesclerk information specifying the salesclerk from said client terminal, and
said reading unit reads an estimated price to be automatically transmitted from said estimated price database based upon the salesclerk information and the specification information.

9. The sales support server according to claim 1,
wherein said estimated price database stores an estimated price to be automatically transmitted for all specifications of the vehicle, and
said reading unit reads an estimated price to be automatically transmitted for the same specifications as specification included in the specification information received by said reception unit.

10. The sales support server according to claim 1,
wherein said estimated price database stores an estimated price to be automatically transmitted for specifications of a part of the vehicle, and
in the case in which an estimated price to be automatically transmitted of the specification information received by said reception unit is not stored in said estimated price database, said reading unit reads an estimated price to be automatically transmitted of specifications close to the specification information.

11. The sales support server according to claim 1,
wherein said estimated price database stores an estimated price to be automatically transmitted for specifications of a part of the vehicle,
in the case in which an estimated price to be automatically transmitted of the specification information received by said reception unit is not stored in said estimated price database, said reading unit reads an estimated price to be automatically transmitted of specifications close to the specification information, and
said control unit corrects the read estimated price to be automatically transmitted and sends the estimated price to be automatically transmitted to said client terminal by said first transmission unit as an estimated price to be automatically transmitted corresponding to the specification information received by said reception unit.

12. The sales support server according to claim 1,
wherein said sales support server is managed by a manufacturer of the vehicle, and
an estimated price to be automatically transmitted included in said estimated price database cannot be updated freely by the manufacturer but can be updated only by access from said dealer terminal.

13. The sales support server according to claim 1,
wherein said reception unit further receives client information specifying a client from said client terminal,
said control unit decides whether to send an estimated price to be automatically transmitted stored in said estimated price database to said client terminal or to inquire an estimated price from said dealer according to the client information received by said reception unit, and
in the case in which said control unit decides that said sales support server should inquire an estimated price from said dealer, said second transmission unit sends the client information and the specification information received by said reception unit to said dealer terminal.

14. The sales support system according to claim 13,
wherein said sales support server is capable of communicating with an automatic reply prohibited client database in which clients to whom an estimated price to be automatically transmitted should not be automatically sent are registered, and
said control unit refers to said automatic reply prohibited client database and, if the client information received by said reception unit is included in said automatic reply prohibited client database, decides that the sales support server should inquire an estimated price from said dealer.

15. The sales support server according to claim 13,
wherein said sales support server is capable of communicating with a number of times of estimation database in which the number of times estimation is requested is stored for each client, and
said control unit refers to said number of times of estimation database and, in the case in which a client, who has made the estimation request received by said reception unit, requested estimation a predetermined number of times or more in the past, decides that the sales support server should inquire an estimated price from said dealer.

16. The sales support server according to claim 1,
wherein said reception unit is capable of further receiving a comment made by the client, and
in the case in which said reception unit receives the comment, said control unit decides that the sales support server should inquire an estimated price from said dealer.

17. The sales support server according to claim 1,
wherein said estimated price database stores specifications of a vehicle for a plurality of types of vehicles, an estimated price to be automatically transmitted in selling the vehicle, and first calculator identification information of a person who has calculated the estimated price to be automatically transmitted associating them with each other,
said reception unit further receives second calculator identification information of a person who should calculate an estimated price from said client terminal,
said control unit decides whether or not said first calculator identification information corresponding to the estimated price to be automatically transmitted of the specification information received by said reception unit and said second calculator identification information received by said reception unit are different, and
in the case in which said control unit decides that the first calculator identification information and the second calculator identification information are different, said second transmission unit sends the estimated price to be automatically transmitted to said dealer terminal and requests approval on transmitting the estimated price to be automatically transmitted to said client terminal.

18. A sales support server which is capable of communicating with an estimated price database, in which specifications for vehicles and estimated prices to be automatically transmitted of the vehicles are stored in association with each other for a plurality of kinds of vehicles, a dealer terminal used by a dealer of vehicles, and a client terminal each other via a network, the sales support server comprising:
reception means which receives specification information specifying specifications for a vehicle and an estimation request from said client terminal;
reading means which reads an estimated price to be automatically transmitted from said estimated price database based upon the specification information;
first transmission means which sends the estimated price to be automatically transmitted read by said reading means to said client terminal;
second transmission means which sends the specification information received by said reception means to said dealer terminal in order to inquire an estimated price from said dealer; and
control means which, when the estimation request is received by said reception means, decides whether to send the estimated price to be automatically transmitted stored in said estimated price database to said client terminal or to inquire the estimated price from said dealer, and controls said first transmission means or said second transmission means.

19. The sales support server according to claim 18,
wherein said reception means further receives client information specifying a client from said client terminal,
said control means decides whether to send an estimated price to be automatically transmitted stored in said estimated price database to said client terminal or to inquire an estimated price from said dealer according to the client information received by said reception means, and
in the case in which said control means decides that said sales support server should inquire an estimated price from said dealer, said second transmission means sends the client information and the specification information received by said reception means to said dealer terminal.

20. The sales support server according to claim 18,
wherein said reception means is capable of further receiving a comment made by the client, and
in the case in which said reception means receives the comment, said control means decides that the sales support server should inquire an estimated price from said dealer.

21. The sales support server according to claim 18,
wherein said estimated price database stores specifications of a vehicle for a plurality of types of vehicles, an estimated price to be automatically transmitted in selling the vehicle, and first calculator identification information of a person who has calculated the estimated price to be automatically transmitted associating them with each other,
said reception means further receives second calculator identification information of a person who should calculate an estimated price from said client terminal,
said control means decides whether or not said first calculator identification information corresponding to the estimated price to be automatically transmitted of the specification information received by said reception means and said second calculator identification information received by said reception means are different, and
in the case in which said control means decides that the first calculator identification information and the second calculator identification information are different, said second transmission means sends the estimated price to be automatically transmitted to said dealer terminal and requests approval on transmitting the estimated price to be automatically transmitted to said client terminal.

22. A sales support system, including: a sales support server managed by a manufacturer of vehicles; a dealer terminal used by a dealer of vehicles; a client terminal; and an estimated price database, in which specifications for vehicles and estimated prices to be automatically transmitted for the vehicles are stored in association with each other for a plurality of kinds of vehicles, the sales support server, the dealer terminal, the client terminal, and the estimated price database are capable of communicating with each other via a network,
wherein said sales support server comprises:
a reception unit which receives specification information specifying specifications for a vehicle and an estimation request from said client terminal;
a reading unit which reads an estimated price to be automatically transmitted from said estimated price database based upon the specification information;
a first transmission unit which sends the estimated price to be automatically transmitted read by said reading unit to said client terminal;
a second transmission unit which sends the specification information received by said reception unit to said dealer terminal in order to inquire an estimated price from said dealer; and
a control unit which, when the estimation request is received by said reception unit, decides whether to send the estimated price to be automatically transmitted stored in said estimated price database to said client terminal or to inquire the estimated price from said dealer, and controls said first transmission unit or said second transmission unit.

23. The sales support system according to claim 22,
wherein said reception unit further receives client information specifying a client from said client terminal,
said control unit decides whether to send an estimated price to be automatically transmitted stored in said estimated price database to said client terminal or to inquire an estimated price from said dealer according to the client information received by said reception unit, and
in the case in which said control unit decides that said sales support server should inquire an estimated price from said dealer, said second transmission unit sends the client information and the specification information received by said reception unit to said dealer terminal.

24. The sales support system according to claim 22, the sales support server according to claim 1,
wherein said reception unit is capable of further receiving a comment made by the client, and
in the case in which said reception unit receives the comment, said control unit decides that the sales support server should inquire an estimated price from said dealer.

25. The sales support system according to claim 22,
wherein said estimated price database stores specifications of a vehicle for a plurality of types of vehicles, an estimated price to be automatically transmitted in selling the vehicle, and first calculator identification information of a person who has calculated the estimated price to be automatically transmitted associating them with each other,
said reception unit further receives second calculator identification information of a person who should calculate an estimated price from said client terminal,
said control unit decides whether or not said first calculator identification information corresponding to the estimated price to be automatically transmitted of the specification information received by said reception unit and said second calculator identification information received by said reception unit are different, and
in the case in which said control unit decides that the first calculator identification information and the second calculator identification information are different, said second transmission unit sends the estimated price to be automatically transmitted to said dealer terminal and requests approval on transmitting the estimated price to be automatically transmitted to said client terminal.

26. A sales support method which uses a sales support server managed by a manufacturer of vehicles, a dealer terminal used by a dealer of vehicles, a client terminal, and an estimated price database in which specifications for vehicles and estimated prices to be automatically transmitted for the vehicles are stored in association with each other for a plurality of kinds of vehicles, the sales support method comprising:
a reception step in which said sales support server receives specification information specifying specifications for a vehicle and an estimation request from said client terminal;
a decision step of, when the estimation request is received in the reception step, deciding whether to send an estimated price to be automatically transmitted stored in said estimated price database to said client terminal or to inquire an estimated price from said dealer;
a first transmission step of, if it is decided in said decision step to send the estimated price to be automatically transmitted stored in said estimated price database to said client terminal, reading the estimated price to be automatically transmitted from said estimated price database based upon the specification information received in said reception step and sending the estimated price to said client terminal; and
a second transmission step of, if it is decided in said decision step to inquire the estimated price from said dealer, sending the specification information received in said reception step to said dealer terminal.

27. The sales support method according to claim 26,
wherein, in said reception step, client information specifying a client is received from said client terminal,
in said decision step, it is decided whether to send an estimated price to be automatically transmitted stored in said estimated price database to said client terminal or to inquire an estimated price from said dealer according to the client information received in said reception step, and
in said second transmission step, in the case in which it is decided in said decision step said sales support server should inquire an estimated price from said dealer, the client information and the specification information received in said reception step to said dealer terminal.

28. The sales support method according to claim 26,
wherein, in said reception step, a comment made by the client can be further received from said client terminal, and
in said decision step, in the case in which the comment is received in said reception step, it is decided that said sales support server should inquire an estimated price from said dealer.

29. The sales support method according to claim 26,
wherein said estimated price database stores specifications of a vehicle for a plurality of types of vehicles, an estimated price to be automatically transmitted in selling the vehicle, and first calculator identification information of a person who has calculated the estimated price to be automatically transmitted associating them with each other,
in said reception step, second calculator identification information of a person who should calculate an estimated price is further received from said client terminal,
in said decision step, it is decided whether or not said first calculator identification information corresponding to the estimated price to be automatically transmitted of the specification information received in said reception step and said second calculator identification information received in said reception step are different, and
in said second transmission step, in the case in which it is decided in said decision step that the first calculator identification information and the second calculator identification information are different, the estimated price to be automatically transmitted is sent to said dealer terminal and approval on transmitting the estimated price to be automatically transmitted to said client terminal is requested.
